(19) United States
(12) Patent Application Publication
(10) Pub. No.: US 2010/0071500 A1
(43) Pub. Date: Mar. 25, 2010

(54) PEDAL DEVICE OF AUTOMOTIVE VEHICLE

(75) Inventors: Tomonori Ohtsubo, Hiroshima (JP); Daisuke Umetsu, Hiroshima (JP); Asami Iwamoto, Hiroshima (JP); Hiroki Uemura, Hiroshima (JP); Yusaku Takeda, Hiroshima (JP)

Correspondence Address: Studebaker & Brackett PC, One Fountain Square, 11911 Freedom Drive, Suite 750, Reston, VA, 20190, US

(73) Assignee: MAZDA MOTOR CORPORATION, Hiroshima (JP)

(21) Appl. No.: 12/538,675

(22) Filed: Aug. 10, 2009

(30) Foreign Application Priority Data
Sep. 22, 2008 (JP) 2008-242985
Sep. 22, 2008 (JP) 2008-242986

(51) Int. Cl. G05G 1/30

(52) U.S. Cl. 74/513

(57) ABSTRACT

There is provided a pedal device of an automotive vehicle, which comprises a plate-shaped pedal body, a lower end of which is rotatably supported at a pivot (support axis) which is disposed on a vehicle floor at a position where a foot of a driver seated in a driver's seat is to be located, the pedal body being provided so as to rotate around the pivot and swing longitudinally according to a pressing operation of the driver's foot, and a slant-face member which is provided behind the pivot which supports the lower end of the pedal body, the slant-face member having a slant upper face which extends obliquely rearward and downward with a slant angle within a rage of 13.5 to 23.5 degrees.

### BACKGROUND OF THE INVENTION

The present invention relates to a pedal device of an automotive vehicle which comprises a plate-shaped pedal body, a lower end of which is rotatably supported at a pivot which is disposed on a vehicle floor at a position where a foot of a driver seated in a driver's seat is to be located, the pedal body being provided so as to rotate around the pivot and swing longitudinally according to a pressing operation of the driver's foot.

Conventionally, in the organ type of pedal for a vehicle which is provided at a vehicle floor on a driver's seat side, which is disclosed in Japanese Patent Laid-Open Publication No. 2008-59202, for example, it is known to form the pressing face of the pedal, on which the pressing force of the driver acts, with an arc face (concave face) in a side view which corresponds to the convex face of the back face of the driver's shoe so that the back face of the driver's shoe can properly fit the pedal-pressing face, thereby improving the controllability of the pedal by the driver.

Further, as disclosed in Japanese Patent Laid-Open Publication No. 2007-109162, the operational assist device of a pressing type of pedal is known. In this device, a step for the heel of the driver's foot being placed thereon is located on the vehicle floor below the pedal which rotates forward and downward around the pedal's lower end. Herein, this step has the pressing-support shape which can maintain the proper support state of the heel of the driver's foot during the whole area of movable range of the pedal, so that the stable pedal operation can be provided without the heel of the driver's foot rising off the step.

According to the pedal for a vehicle disclosed in the above-described first publication, since the side-face shape of the pedal pressing face is concave so that the contact of the back face of the driver's shoe with the pedal pressing face can be a face contact, so that the operational function of the pedal can be improved. However, since the size of the driver seated in the driver's seat may change, it would be impossible to set the pedal's pressing face so that the curvature of the concave face of the pedal's pressing face could properly to all drivers who are possibly seated. For example, in case a short driver having a relatively-short foot's length is seated, the ball of the driver's hoot may contact a specified portion which is located below the appropriate position of the pedal's pressing face, so that the operational force may lack due to an insufficient lever ratio. Meanwhile, in case a tall driver having a relatively-long foot's length is seated, the ball of the driver's hoot may contact an upper portion of the pedal body, so that it may be difficult to position the ball of the driver's foot at the pedal's pressing face and thereby the driver may have uncomfortable feelings and the like.

Meanwhile, according to the device in which the above-described step has the pressing-support shape with the upper face which comprises the first pressing face and the second pressing face as shown in the above-described second publication, the forward move of the heel of the driver's foot may be properly prevented at the time of pedal pressing by the engaging portion which is comprised of the pressing-support shape, thereby providing advantages of the stable operation of the pedal and the like. However, in case the engaging portion of the pressing-support shape is positioned between the pivot point at the lower end of the pedal and the heel point of the driver's foot, it may be difficult to make the moving locus of the back face of the driver's foot which rotates around the heel placed on the vehicle floor match the moving locus of the pedal's pressing face which rotates around the hinge pin provided at the pedal's lower end. Accordingly, it may not be avoided despite using the above-described so-called organ type of pedal that the contact point of the back face of the driver's shoe to the pedal's pressing face changes improperly toward the tip of toes of the hoot according to the pressing operation of the pedal. In particular, in case of the short driver having the relatively-short foot's length, the above-described matching between the moving locus of the back face of the driver's foot and the moving locus of the pedal's pressing face becomes more difficult, so the driver would tend to feel the uncomfortable feelings further.

### SUMMARY OF THE INVENTION

The present invention has been devised in view of the above-described matters, and an object of the present invention is to provide a pedal device of an automotive vehicle which can make the ball of the driver's hoot contact an appropriate position of a pedal body regardless of the hoot's length of the driver, thereby improving the operational function of the pedal.

According to the present invention, there is provided a pedal device of an automotive vehicle, comprising a plate-shaped pedal body, a lower end of which is rotatably supported at a pivot which is disposed on a vehicle floor at a position where a foot of a driver seated in a driver's seat is to be located, the pedal body being provided so as to rotate around the pivot and swing longitudinally according to a pressing operation of the driver's foot, and a slant-face member provided behind the pivot which supports the lower end of the pedal body, the slant-face member having a slant upper face which extends obliquely rearward and downward with a slant angle within a rage of 13.5 to 23.5 degrees.

According to the present invention, even the relatively-short driver can conduct the pressing operation of the pedal easily and properly with the appropriate lever ratio in the state in which the ball of the driver's foot is made contact the appropriate position of the pressing portion of the pedal body, maintaining the proper angles of the ankle's angle and the sole's inclination angle with the driver's heel being stably placed on the slant-face member.

According to an embodiment of the present invention, the pedal body includes a pressing portion which the ball of the hoot of the driver who places a heel thereof on the slant upper face of the slant-face member contacts, and the pressing portion of the pedal body has a convex face which projects rearward of the vehicle. Thereby, the back face of the driver's shoe is made contact a point of the convex face of the pressing portion with a line contact, so that the contact position of the back face of the driver's shoe with the pressing portion of the pedal body can change smoothly and continuously according to the pressing of the pedal in a state in which the heel of the driver's hoot is placed at a specified position which is located rearward from the pivot of the pedal body.

According to another embodiment of the present invention, the pedal body is a pedal body of an accelerator pedal of the vehicle, a brake pedal is disposed on a left side of the accelerator pedal, and a layout of the accelerator pedal and the brake pedal is configured in such a manner that an imaginary line which extends obliquely downward and toward a right side from a pressing portion of the brake pedal with an inclination angle of about 45 degrees passes through a lower half portion of the convex face of the pressing portion of the accelerator pedal. Accordingly, there may not occur any problems in that the driver is forced to take an uneasy position in which the driver has to make the heel portion contact the upper portion of the accelerator pedal by twisting the right hoot greatly, or that the large pressing force is required because of the small lever ratio by the contact of the heel portion with the lower portion of the accelerator pedal. Thus, both the brake pedal and the accelerator pedal can be operated properly for executing the heel-and-toe driving.

According to another embodiment of the present invention, a concave face portion is formed at the pedal body which is located between the pressing portion and the pivot, the concave face portion being configured to be recessed forward from an imaginary line which connects the pressing portion and the pivot of the pedal body, and an S-shaped continuous curve face of the pedal body is formed by the concave face portion and the convex face portion. Thereby, the heel portion of the driver's hoot can be prevented from contacting the base end portion of the pedal body during the pressing operation of the pedal with the simple structure. Further, the driver's having the uncomfortable feelings which may be caused by the contact of the upper portion of the pedal body with the toe portion of the back face of the driver's hoot can be effectively prevented, and the superior design of the operational pedal can be provided.

According to another embodiment of the present invention, the pedal device of an automotive vehicle further comprises a base member of a pedal unit which supports the pedal body, wherein the slant-face member and the base member are formed integrally. Thereby, the structure or the attachment of the pedal device can be made simple, by reducing the number of parts properly. Further, positions of the pedal body and the slant-face member can be set properly so as to match each other.

Other features, aspects, and advantages of the present invention will become apparent from the following description which refers to the accompanying drawings.

### BRIEF DESCRIPTION OF THE DRAWINGS

FIG. 1 is an explanatory diagram showing an embodiment of a pedal device of an automotive vehicle according to the present invention.

FIG. 2 is a side view showing a specific structure of an accelerator pedal.

FIG. 3 is an exploded perspective view showing the specific structure of the accelerator pedal.

FIG. 4 is a sectional view taken along line IV-IV of FIG. 2.

FIG. 5 is a back view showing a disposition state of the accelerator and brake pedals.

FIG. 6 is a side view showing a specific structure of a seat adjusting mechanism.

FIG. 7 is a perspective view showing the specific structure of the seat adjusting mechanism.

FIG. 8 is a sectional view taken along line VIII-VIII of FIG. 6.

FIG. 9 is a side sectional view showing a specific structure of an inclination-angle adjusting mechanism.

FIG. 10 is a plan sectional view showing the specific structure of the inclination-angle adjusting mechanism.

FIG. 11 is a side view showing a state in which a seat cushion is moved forward of a vehicle body.

FIG. 12 is a side view showing sitting states of an average driver and a short driver.

FIG. 13 is an explanatory diagram showing a state in which respective heels of the average driver and the short driver are placed.

FIG. 14 is a side view showing sitting states of a tall driver and the average driver.

FIG. 15 is an explanatory diagram showing a state in which the heel of the tall driver is placed.

FIG. 16 is a diagram showing a comparative example of the accelerator pedal, which corresponds to FIG. 2.

FIG. 17 is a diagram showing another comparative example of the accelerator pedal, which corresponds to FIG. 2.

### DETAILED DESCRIPTION OF THE INVENTION

Hereinafter, a preferred embodiment of the present invention will be described.

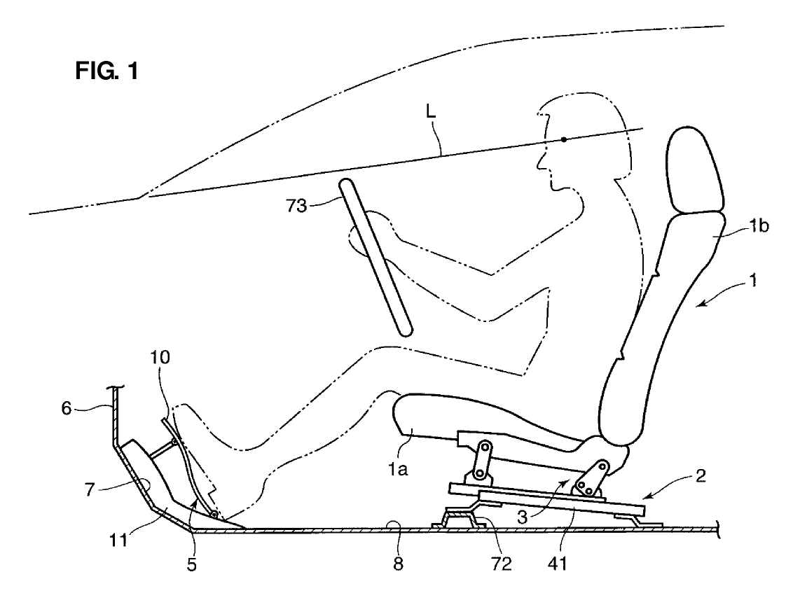

FIGS. 1 through 4 show an embodiment of a pedal device of an automotive vehicle according to the present invention. The automotive vehicle includes a seat adjusting mechanism which is disposed in a vehicle compartment and comprises a longitudinal-position adjusting mechanism 2 which allows a slide move of a seat cushion 1a of a driver's seat and adjusts its longitudinal position, and an inclination-angle adjusting mechanism 3 which adjusts an inclination angle of the seat cushion 1a. Further, at a front portion of the vehicle compartment are provided operational pedals, such as an accelerator pedal 4, which are operationally pressed by a driver seated in a driver's seat 1.

There are provided, at a vehicle body of the automotive vehicle, a dash panel 6 which partitions the vehicle compartment from an engine room, a kick-up portion 7 which extends rearward in a slant state from a lower end of the dash panel 6, and a vehicle floor 8 which extends rearward in a flat state from a rear end of the kick-up portion 7. On an upper face of the vehicle floor 8 is provided a well-known floor trim member (not illustrated) which comprises an insulator which is made of felt, glass wool or another material, having the function of sound and heat insulation, and a skin member which is made of a carpet material or the like and covers over the insulator.

The above-described accelerator pedal 4 is an organ type of pedal unit, a lower end of which is rotatably supported at a pivot equipped with a support axis 9 which is disposed on the vehicle floor 8 at a position where a foot of a driver seated in the driver's seat 1 is to be located during driving. The accelerator pedal 4 comprises a pedal body 10 which swings longitudinally according to a pressing operation of the driver's foot, a base member 11 which supports the pedal body 10, and a pedal operation detecting portion 12 which detects a swinging move of the pedal body 10 and outputs a detection signal to a controller, not illustrated.

The pedal body 10 is comprised of a plate-shaped forming member which includes an insertion portion 14, into which the support axis 9 is inserted, at its lower end. The pedal body 10 also has a pressing portion 16 at its middle portion which a ball of the driver's hoot contacts. This pressing portion 16 has a convex face which projects rearward of the vehicle having the curvature radius R1 of 150 to 200 mm when viewed from the side.

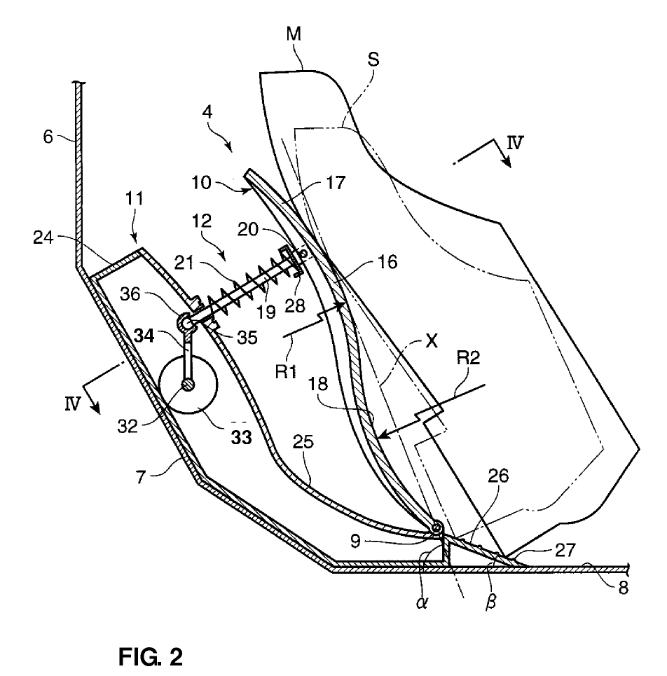

Further, a bend portion 17 is formed at the pedal body 10 which is located above the pressing portion 16. This bend portion 17 is configured to curve forward from an imaginary line X which interconnects the pressing portion 16 and the support axis 9 of the pivot. Herein, the bend portion 17 curves forward in such a manner that its upper-side portion curves more greatly so as to be away from the imaginary line X as shown in FIG. 2. This bend portion 17 is comprised of a curve face which has substantially the same curvature radius as that of the pressing portion 16 so as to be continuous from the pressing portion 16. The total length of the pressing portion 16 and the bend portion 17 is set to 120 mm.

Moreover, a concave face portion 18 is formed at the pedal body 10 which is located below the pressing portion 16. This concave face portion 18 is configured to be recessed forward from the above-described imaginary line X, having the curvature radius R2 of 100 to 150 mm when viewed from the side. Thus, an S-shaped continuous curve face which is formed by the convex face portion which is comprised of the pressing portion 16 and the bend portion 17, and the concave face portion 18. Herein, by setting the length of the concave face portion 18 to about 100 mm, for example, the ball of the driver's hoot may be positioned so as to contact the pressing portion 16 in a state in which the heel of the driver's hoot is placed on the vehicle floor 8 in front of the driver's seat 1 or a slant face portion 26 (corresponding to a “slant-face member” in claims), which will be described later.

An operational rod 19 which constitutes the pedal operation detecting portion 12 is rotatably supported at the back face of the pedal body 10 via a connecting pin 20 or the like. The lower end of the pedal body 10 is supported by the support axis 9 of the pivot which is provided at the base member 11 at its lower end, and the upper portion of the pedal portion 10 is supported by the base member 11 via a pedal support spring 21 which is disposed around the operational rod 19. Thus, in the normal (non-operational) state, the pedal body 10 is held at an inclination position in which the inclination angle α of the above-described imaginary line X relative to the horizontal line is 70 degrees, for example.

The above-described base member 11 comprises a box 24 which has an outer-peripheral attaching portion 23 which is equipped with some holes for stud bolts 22 which are formed at a lower end portion of the dash panel 6 and the vehicle floor 8, and a lid 25 which is attached to cover the box 24 so as to cover an upper opening of the box 24. Herein, behind the box 24 is provided the slant face portion (slant-face member) 26 which has the height of about 20 mm, the length of about 50 mm, and its slant upper face which extends obliquely rearward and downward with the slant angle within the rage of 13.5 to 23.5 degrees. The slant face portion 26 is formed in a fan shape in the plan view, and has arc-shaped several projections 27 on its upper face. Thereby, the heel of the driver's hoot (shoe) is prevented from improperly slipping over the slant face portion 26 during the driving.

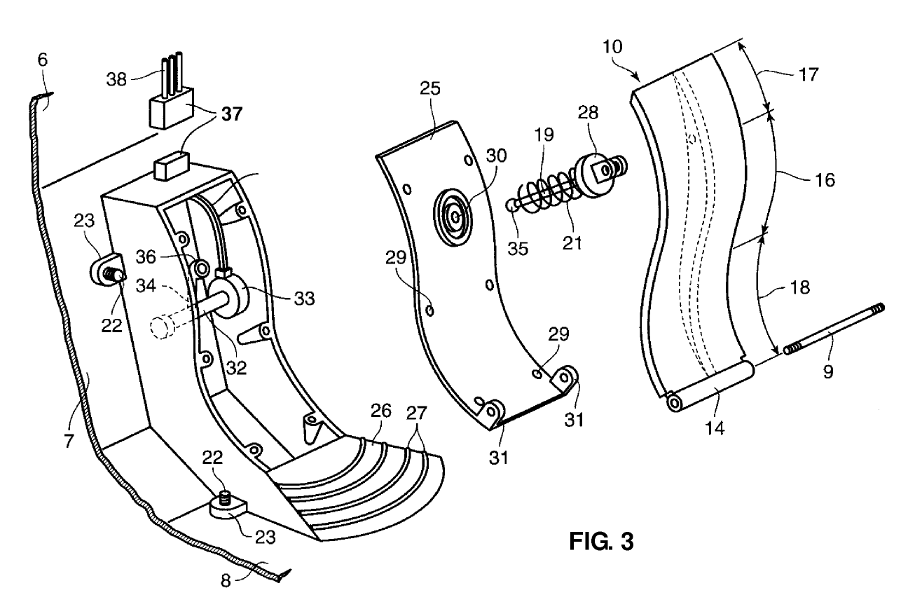

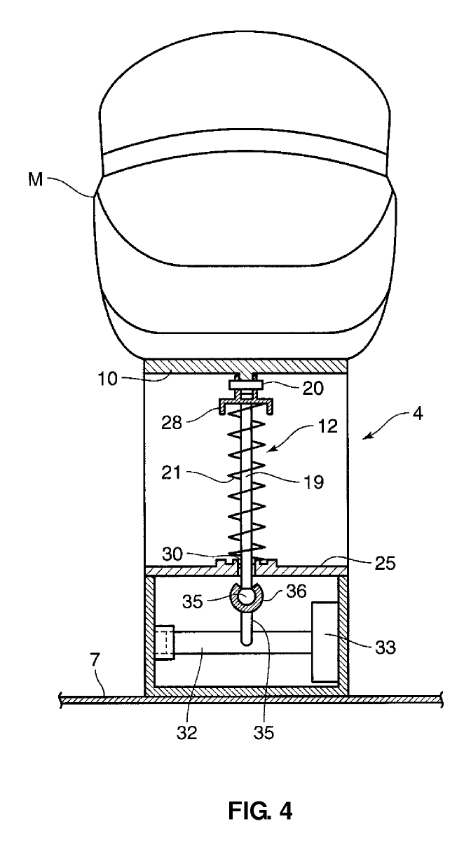

The lid 25 has an outer periphery which has some holes through which screws (not illustrated) are inserted. The screws are inserted through these holes and engage with screw holes which are formed at a peripheral wall portion of the box 24 for attaching. The lid 25 has also a through hole 30 for the above-described operational rod 19 at its upper center. A lower end of the above-described pedal support spring 21 is supported by a peripheral edge portion of the through hole 30. Further, the lid 25 has a pair of support portions 31 which supports both-side ends of the support axis 9 at its lower end. Herein, in FIGS. 3 and 4, a reference numeral 28 denotes a spring seat to support an upper end of the pedal support spring 21.

Inside the box 24 of the base member 11 is rotatably supported an encoder shaft 32 which is driven according to the pedal operation. An encoder 33 which detects the rotational move amount of the encoder shaft 32 is provided at a base end of the encoder shaft 32. Further, a drive arm 34 is provided at a central periphery of the encoder shaft 32, and a connection portion 36 is formed at the tip of the drive arm 34. A ball portion 35 is formed at a base end of the operational rod 19, and this ball portion 35 rotatably engages with the connection portion 36 of the drive arm 34 via an insertion coupling.

Herein, the above-described stud bolts 22 are inserted into the attaching portions 23 of the base member 11, then fixing nuts are attached to their tip ends of the stud bolts 22 for fastening the base member 11 to the portion in front of the driver's seat 1. Thus, the accelerator pedal 4 is disposed at a specified position on the vehicle floor 8 where the heel of the driver's right hoot is placed. Further, the above-described slant face portion 26 is disposed behind the pedal 4.

According to the above-described structure, when the pedal body 10 is operated (pressed) by the driver in a state in which the ball of the driver's foot contacts the pressing portion 16 of the pedal body 10 with the heel being placed on the slant face portion 26, the pedal body 10 is pressed against the sprig force of the pedal support spring 21 so as to swing forward around the support axis 9 of the pivot. When this driving force applied to the pedal body 10 is transmitted to the encoder shaft 32 via the operational rod 19 and the drive arm 34, the encoder shaft 32 rotates and this rotational move amount is detected by the encoder 33. This detection signal is outputted to the controller, not illustrated, via connectors 37 and harnesses 38.

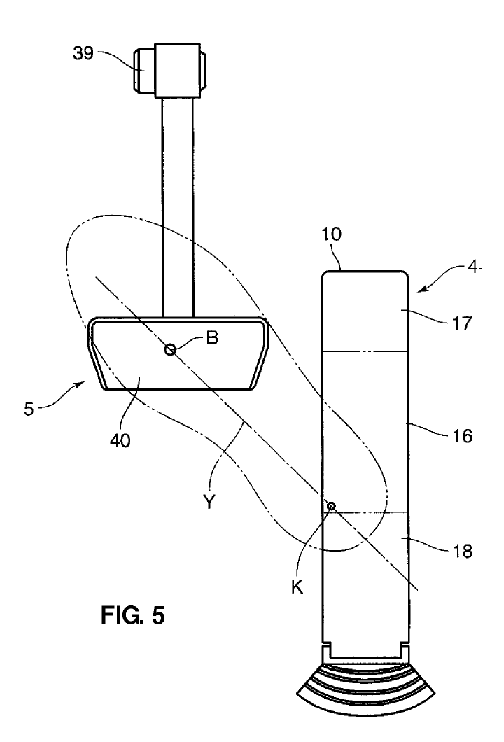

As shown in FIG. 5, the hanging type of brake pedal 5 is disposed on the left side of the accelerator pedal 4. The upper end portion of this pedal 5 is rotatably supported via a pivot 39, and its lower end portion has a pressing portion 40. The layout of the brake pedal 5 and the accelerator pedal 10 is configured in such a manner that an imaginary line Y which extends obliquely downward and to the right from the pressing portion 40 of the brake pedal 5 with the inclination angle of about 45 degrees passes through the lower half portion of the convex face portion of the pressing portion 16 of the accelerator pedal 4.

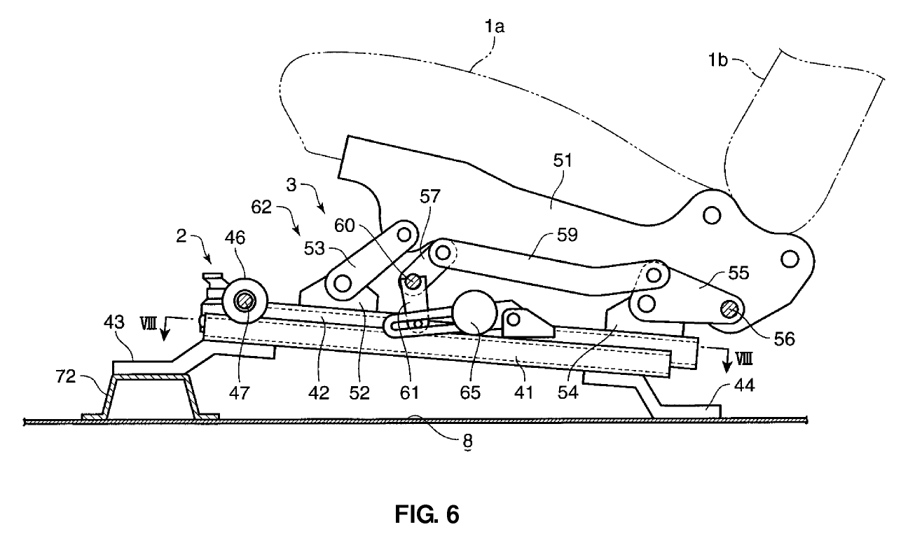

As shown in FIGS. 6 through 8, a pair of seat-slide lower rails 41 which supports the seat cushion 1a so that the seat cushion 1a can move longitudinally is provided at the disposition portion of the driver's seat 1, and a pair of seat-slide upper rails 42 is provided so as to slide along the seat-slide lower rails 41. The seat-slide lower rails 41 is made of a C-type steel member or the like which has an opening on the top thereof, and attaching brackets 43, 44 are fixed to their both longitudinal ends by welding or the like. These brackets 43, 44 are fixed to an upper face of a cross member 72 and the like by fastening bolts or the like, so that the seat-slide lower rails 41 is disposed on the vehicle floor 8 in a slant state in which the level of its front portion is slightly higher.

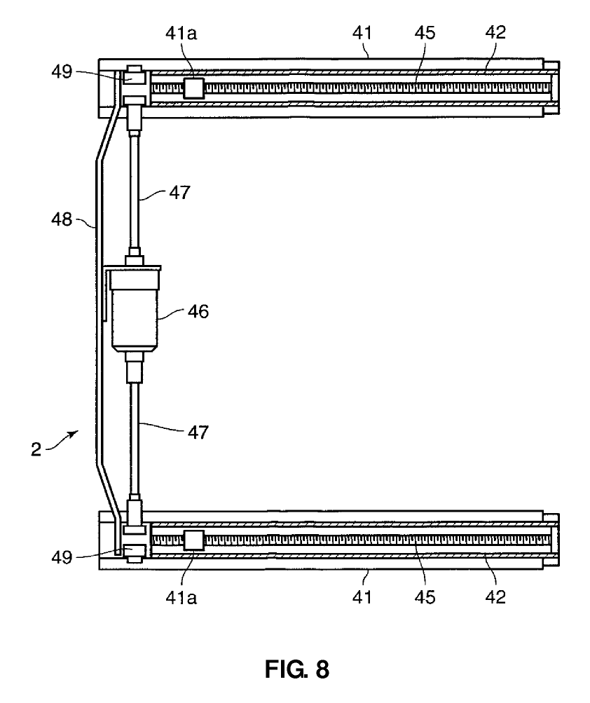

As shown in FIG. 8A, a thread rotational shaft 45 is disposed inside each of the seat-slide lower rails 41, and a pair of drive shafts 47 which is rotated by a drive motor 46 and a support member 48 which supports the drive shafts 47 are provided respectively so as to extend in a vehicle width direction between both front ends of the seat-slide upper rails 42. At both-side end portions of the drive shafts 47 are provided drive-force transmitting portions 49 which transmit a drive force to the rotational shafts 45 via a mechanism which comprises a bevel gear or worm gear.

The above-described seat-slide lower rails 41, seat-slide upper rails 42, rotational shaft 45, drive motor 46, drive shaft 47 and drive-force transmitting portion 49 constitute the longitudinal-position adjusting mechanism 2 together with a pair of nut blocks 41a which is fixed to respective bottom portions of the seat-slide lower rails 41 and engages with the respective rotational shafts 45. The longitudinal-position adjusting mechanism 2 adjusts the longitudinal position of the driver's seat 1 by making the seat cushion 1a of the driver's seat 1 slide along the seat-slide lower rails 41.

For example, when a longitudinal adjusting switch, not illustrated, is operated for a forward moving, a control signal to rotate the drive motor 46 in its normal direction is outputted and the diver motor 46 is rotated in the normal direction by this control signal. Thereby, the drive force for moving the seat cushion 1a forward is transmitted to the drive shafts 47, drive-force transmitting portions 49, and rotational shafts 45. The rotational shafts 45 are rotated by the drive force inputted via the drive-force transmitting portions 49 in the state in which these shafts 45 are supported at the nut blocks 41a which are fixed to the bottom portions of the seat-slide lower rails 41, so that the rotational shafts 45 proceed forward. Consequently, the seat-slide upper rails 42 and thereby the seat cushion 1a of the driver's seat 1 are moved forward.

Meanwhile, when the longitudinal adjusting switch is operated for a rearward moving, a control signal to rotate the drive motor 46 in its reverse direction is outputted and the diver motor 46 is rotated in the reverse direction by this control signal. Thereby, the drive force for moving the seat cushion 1a rearward is transmitted to the drive shafts 47, drive-force transmitting portions 49, and rotational shafts 45. The rotational shafts 45 are rotated by the drive force, so that the rotational shafts 45 proceed rearward. Consequently, the seat-slide upper rails 42 and thereby the seat cushion 1a of the driver's seat 1 are moved rearward.

Further, since the seat-slide lower rails 41 is disposed on the vehicle floor 8 in the slant state in which the level of its front portion is slightly higher, the seat cushion 1a is pushed upward as the seat-slide upper rails 42 and the seat cushion 1a of the driver's seat 1 move forward along the seat-slide lower rails 41. On the contrary, the seat cushion 1a is lowered as the seat-slide upper rails 42 and the seat cushion 1a of the driver's seat 1 move rearward along the seat-slide lower rails 41.

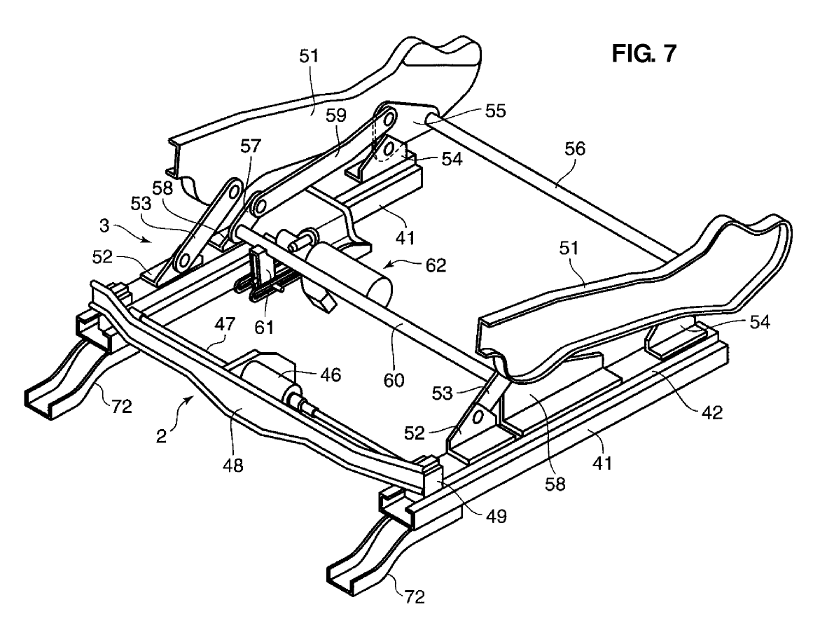

Moreover, at each of the seat-slide upper rails 42 is provided the inclination-angle adjusting mechanism 3 which adjusts the inclination angle of the seat cushion 1a of the driver's seat 1. The inclination-angle adjusting mechanism 3, as shown in FIGS. 6 and 7, comprises a cushion frame 51 which is provided at a side portion of the seat cushion 1a, a front bracket 52 and a front link 53 which are provided on a front upper face of the seat-slide upper rail 42 and supports a front end of the cushion frame 51, a rear bracket 54 and a triangular-shaped rear link 55 which are provided on a rear upper face of the seat-slide upper rail 42 and supports a rear portion of the cushion frame 51, a connecting shaft 56 which interconnects rear end portions of the both-side rear links 55 and rear end portions of the both-side cushion frames 51, a center link 57 which transmits a drive force to the rear link 55 and a center bracket 58 which is provided on a central upper face of the seat-slide upper rail 42 and supports this center link 57, a connecting link 59 which connects an upper portion of the central link 57 to a front end of the rear link 55, a drive shaft 60 which will be described below, and a drive lever 61 and an inclination drive portion 62.

The central link 57 is fixed to the drive shaft 60 which extends in the vehicle width direction at its end portion, and this link 57 is rotatably supported at the central bracket 58 via the drive shaft 60. The drive lever 61 which rotates the drive shaft 60 is fixed to the drive shaft 60. Herein, the above-described inclination drive portion 62 which drives this drive lever 61 is provided at the central bracket 58 which is fixed to either one of the seat-slide upper rails 42 (one on the outward side).

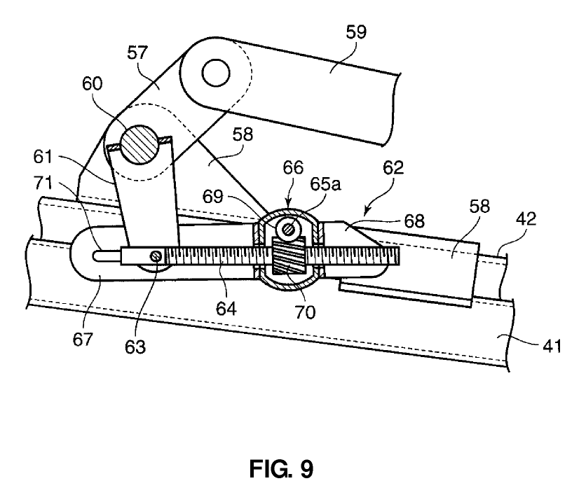

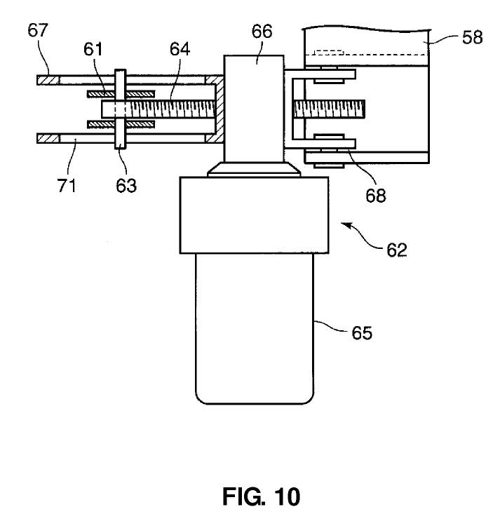

The inclination drive portion 62 comprises, as shown in FIGS. 9 and 10, a screw shaft 64 which is connected to a tip (lower end) of the drive lever 61 via a connecting pin 63 at its front end, a drive motor 65 to rotate the screw shaft 64 and a gear mechanism 66, and a guide bracket 67 which is fixed to a front face of the gear mechanism 66 and a base end of which is supported at the central bracket 58 via a support bracket 68. Further, the gear mechanism 66 comprises a worm gear 69 which is fixed to an output shaft 65a of the drive motor 65 and a worm nut 70 which is rotated by the worm gear 69. The worm nut 70 has a screw hole formed thereat which the screw shaft engages with.

Herein, as the worm nut 70 is rotated by the drive force which is inputted from the drive motor 65 via the worm gear 69, the screw shaft 64 is rotated. Thereby, the connecting pin 63 at the tip of the screw shaft 64 moves longitudinally along a support groove 71 which is formed at the guide bracket 67, and the drive force is transmitted to the drive lever 61 via the connecting pin 63. Accordingly, the drive lever 61 swings and thereby the drive shaft 60 is rotated.

Further, the central link 57 swings according to the rotation of the drive shaft 60, and the rotational drive force is transmitted to the rear link 55 via the connecting link 59. As the rear link 55 swings, the front link 53 also swings. Consequently, the inclination angle of the seat cushion 1a can be adjusted. That is, when the seat cushion 1a of the driver's seat 1 moves to its rear position, as shown in FIG. 6, the front link 53 and the central link 57 take a their rearward slant positions and the connecting shaft 56 which is provided at the rear end of the rear link 55 takes its lower position. Consequently, a sitting face of the seat cushion 1a is held in its slant state in which it rear portion lowers greatly.

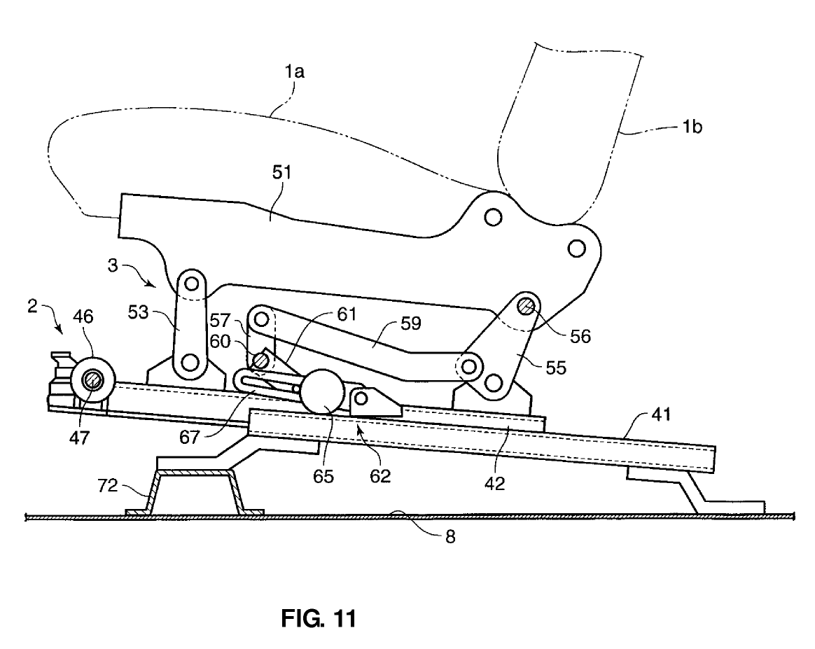

According to the above-described structure, when the forward moving operation of the driver's seat 1 with the longitudinal adjusting switch is conducted, the control signal for rotating the drive motor 65 of the inclination-angle adjusting mechanism 3 in the normal direction is outputted from the controller, not illustrated, based on preset drive characteristics. The driving force of the normal-direction rotation of the drive motor 65 is transmitted to the central link 57 via the gear mechanism 66, screw shaft 64, connecting pin 63, drive lever 61 and drive shaft 60, and thereby the central link 57 changes its position from the rearward slant state to its standing state which is shown in FIG. 11. According to this position change of the central link 57 to the standing state, the drive force is transmitted to the rear link 55 via the connecting link 59, and the front end of the rear link 55 is pulled forward. Accordingly, the connecting shaft 56 which is provided at the rear end of the rear link 55 rises up, so that the rear end potion of the seat cushion 1a is pushed upward.

Further, since the front link 53 moves from its rearward slant state to its standing state according to the swing move of the rear link 55, the seat cushion 1a moves in such a manner that its front end portion rises and moves forward, so that the seat cushion 1a moves from the lower position to the upper position shown in FIG. 11. Herein, since the upper move quantity of the rear end portion of the seat cushion 1a is set to be greater than that of the front end portion of the seat cushion 1a, the seat cushion 1a moves so as to approach a horizontal state gradually. Depending on this move of the seat cushion 1a, the seat back 1b moves so as to approach its upright position.

Meanwhile, when the rearward moving operation of the driver's seat 1 with the longitudinal adjusting switch is conducted, the control signal for rotating the drive motor 65 of the inclination-angle adjusting mechanism 3 in the reverse direction is outputted from the controller, not illustrated, based on preset drive characteristics. The driving force of the reverse-direction rotation of the drive motor 65 is transmitted to the central link 57 via the gear mechanism 66, screw shaft 64, connecting pin 63, drive lever 61 and drive shaft 60. Accordingly, as shown in FIG. 6, the seat cushion 1a changes from the upper position to the lower position. Herein, the drive characteristics are set in such a manner that the rearward inclination angle of the sitting face of the seat cushion 1a increases and the seat back 1b slants rearward greatly depending on the lowering of the seat cushion 1a.

Herein, if the driver seated in the driver's seat 1 changes to a different driver having a different height, the eye point of the driver seated, operational functions for the operational pedals and the like may change because the driver's sitting height, the length of the driver's arm, the length of the driver's leg and the like change as well. Therefore, the new driver may try to operate the longitudinal-position adjusting mechanism 2 and the inclination-angle adjusting mechanism 3 to adjust the driver's position so that the driver can holds a steering wheel 73 in the properly comfortable position, make the ball of the driver's foot properly contact the pressing portion 16 of the pedal body 10 of the accelerator pedal 4, and the clear front view of the driver can be ensured by matching the driver's eye point to an appropriate line L.

The drivers with the height within the range of 150 to 190 cm may be seated in the driver's seat 1, so it is necessary that any driver can be seated in the seat 1 having the comfortable sitting position and conduct the driving operation properly. Herein, the statistical analysis on the appropriate position for the average-sized driver M with the height of 174 cm was conducted, and the results below were obtained.

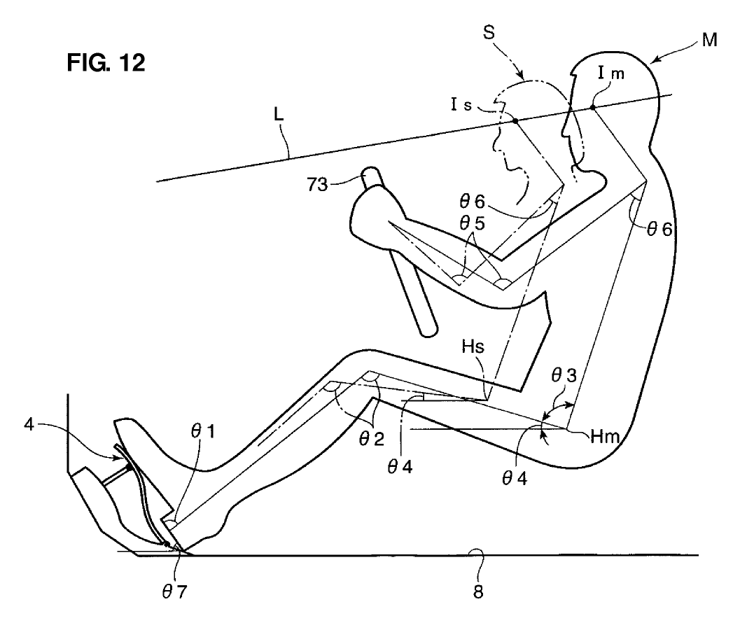

Herein, the comfortable position of the driver seated in the driver's seat 1 means a sitting position which can make the driver keep the sitting state for a long period of time and also suit for operating the steering wheel, pedals and so on. Specifically, as shown in FIG. 12, the angle of ankle θ1 is about 85 to 95 degrees, the angle of knee θ2 is about 115 to 135 degrees, and the bending angle θ3 between the upper half body and the thigh portion is about 95 degrees. Further, it has been recognized from the human-technology tests that the appropriate angle of the thigh angle θ4 relative the horizontal line for the average-sized driver M is an angle which is obtained by adding about 1.5 degrees to the inclination angle of the seat cushion 1a. Further, the elbow angle θ5 which can provide the proper operation of steering wheel 73 is about 100 to 130 degrees, and the armpit portion angle θ6 is about 20 to 45 degrees.

Accordingly, the longitudinal standard position and the vertical standard position of the seat cushion 1a are set so that when the above-described average-sized driver M is seated in the driver's seat in a state, for example, in which the ankle angle θ1 is 90 degrees, the knee angle θ2 is 125 degrees, the bending angle θ3 between the upper half body and the thigh portion is degrees, and the thigh angle θ4 is 17 degrees, the eye point Im of the average-sized driver M can be made match the appropriate line L which has the inclination angle of 8 degrees.

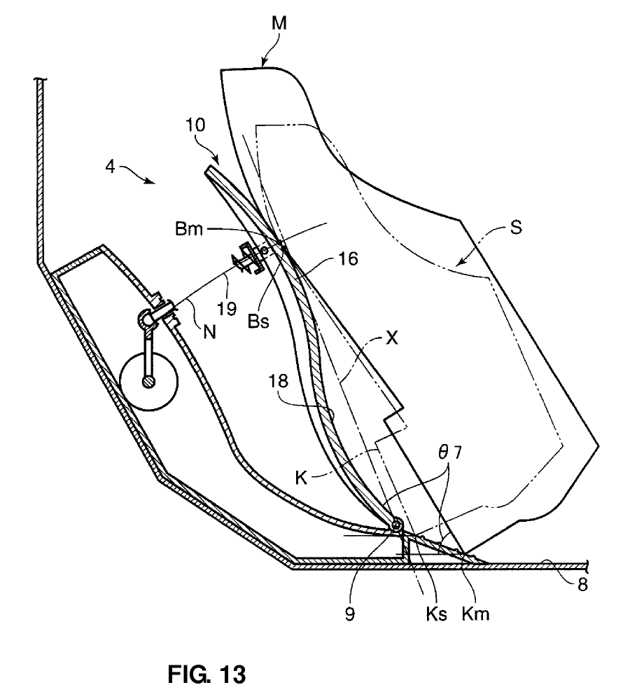

According to the above-described standard sitting state of the average-sized driver M, the elbow angle θ5 and the armpit portion angle θ6 are set within the above-described respective ranges so that the driver can hold the steering wheel 73 properly. Further, as shown in FIG. 13, the above-described pedal unit of the accelerator pedal 4 is disposed so that the ball of the hoot Bm of the driver's hoot can be made contact the appropriate position of the pressing portion 16 of the accelerator pedal 4, that is, the specified position near the disposition position of the operational rod 19 in a state in which a heel's lower end Km of the driver's foot on the pedal is placed on the inclination slant face portion 26 and the inclination angle θ7 of the sole relative to the horizontal line is about 59.5 degrees, for example.

In FIG. 12, a reference character Hm denotes the hip point (sitting standard point) of the average-sized driver M seated in the driver's seat 1. Further, the standard disposition position of the heel's lower end Km of the average-sized driver M is set to a specified position which is 5 mm upward away from the lower end of the slant face portion 26 (the upper face of the vehicle floor 8), that is, near the rear end of the slant face portion 26.

Meanwhile, when the driver seated in the driver' seat 1 changes from the average-sized driver M to the short driver S, such as an woman deriver, as shown by a broken line in FIG. 12, this short driver S may operate the longitudinal-position adjusting mechanism 2 and the inclination-angle adjusting mechanism 3 to move the seat cushion 1a forward so that the operational functions of the steering wheel and the pedal can be ensured and the eye point Is can be matched to the appropriate line L. Further, the driver S may operate to raise the disposition level of the seat cushion 1a and reduce the inclination angle of the seat cushion 1a relative to the horizontal line accordingly.

For example, when the short driver S with the height of 150 cm is seated in the driver's seat 1, the short driver S operates so as to move the hip point Hs on the seat cushion 1a forward about 105 mm from the longitudinal standard position Hm of the average-sized driver M and upward about 25 mm, and to change the inclination angle of the seat cushion 1a so that the thigh angle θ4 can be about 10.5 degrees. As a result, the upper half body of the short driver S who has a shorter arm than that of the average-sized driver M is moved forward so that the steering wheel 73 can be held in the appropriate position, and the eye point Is of the short driver S who has a shorter sitting height than that of the average-sized driver M is moved upward and forward so that the eye point Is can match the appropriate line L.

Moreover, there is a tendency that the pedal-operating foot of the short driver S moves upward and forward according to the upward and forward move of the seat cushion 1a. Therefore, by increasing the knee angle θ2 to about 130 degrees accordingly, the ball of the foot Bs of the short driver S can be made contact the pressing portion 16 of the accelerator pedal 4, keeping the ankle angle θ1 at about 90 degrees.

Since the distance (about 160 cm) from the heel's lower end Ks of the short driver S to the ball of the hoot Bs is about 30 mm shorter than that (about 190 cm) of the average-sized driver M, in order that the ball of the hoot Bs is made contact the pressing portion 16 of the accelerator pedal 4, keeping the sole's inclination angle θ7 of the short driver S at the angle which is the same as that (59.5 degrees) of the average-sized driver, the heel's lower end Ks is located at a level which is about 26 mm (=sin 59.5 degrees×30 mm) higher than the heel's lower end Km of the average-sized driver M. Therefore, unless the heel's lower end Ks of the short driver S is located above off the vehicle floor 8, the ball of the hoot Bs of the short driver S may not be made contact the appropriate position of the pressing portion 16 surely. Meanwhile, in case the heel's lower end Ks of the short driver S is located above off the vehicle floor 8, it may be difficult to operate the pedal precisely with the pivotal move around the heel's lower end Ks.

However, in case the upper face's inclination angle P of the slant face portion 26 is set to 20 degrees, for example, within the range of 13.5 to 23.5 degrees like the above-described embodiment, by changing the sole's inclination angle θ7 of the short driver S from 59.5 degrees to about 67 degrees and moving the heel's lower end Ks about 27 mm forward from the standard position on the slant face portion 26 (the disposition position of the heel's lower end Km of the average-sized driver M), the ball of the hoot Bs can be made contact the appropriate position of the pressing portion 16 of the accelerator pedal 4 in the state in which the heel's lower end Ks is placed at the specified position on the slant face portion 26 which is located about 15 mm above the vehicle floor 8. Herein, there is a tendency that the ankle angle θ1 of the hoot becomes smaller than 90 degrees as the sole's inclination angle θ7 changes from 59.5 degrees to 67 degrees. However, by increasing the knee angle θ2 of the short driver S to a specified angle greater than 130 degrees so that the knee can extend further according to the increase of the sole's inclination angle θ7 (see FIG. 12), it can be prevented that the ankle angle θ1 becomes smaller beyond the appropriate range, for example, smaller than 85 degrees.

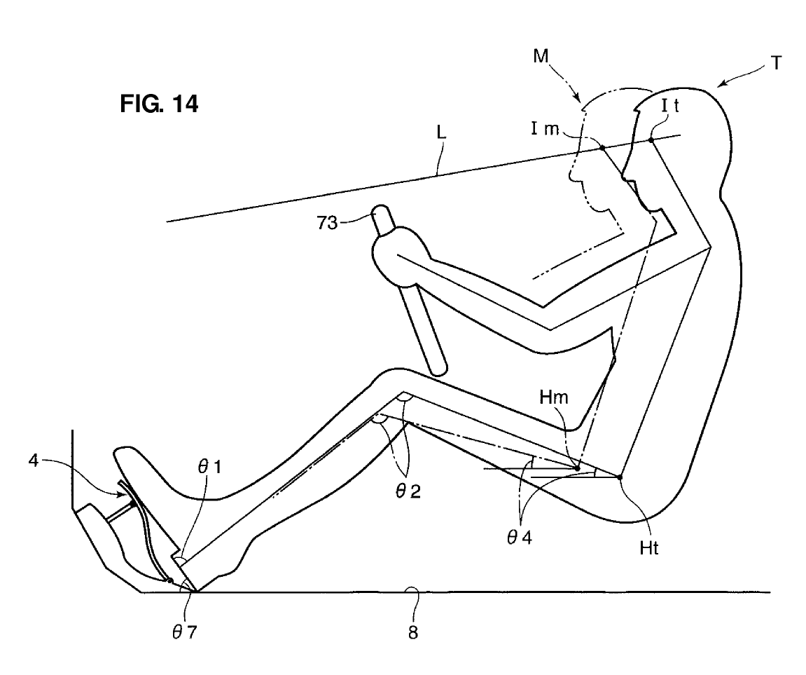

Meanwhile, when the tall driver T with the height of 189 cm is seated in the driver's seat 1, for example, as shown in FIG. 14, the tall driver T operates so as to move the hip point Ht on the seat cushion 1a rearward about 85 mm from the longitudinal standard position Hm of the average-sized driver M and downward about 20 mm, and to change the inclination angle of the seat cushion 1a so that the thigh angle θ4 can become about 20.0 degrees. As a result, the upper half body of the tall driver T who has a longer arm than that of the average-sized driver M is moved rearward so that the steering wheel 73 can be held in the appropriate position, and the eye point It of the tall driver T who has a longer sitting height than that of the average-sized driver M is moved downward and rearward so that the eye point It can match the appropriate line L.

Moreover, there is a tendency that the pedal-operating foot of the tall driver T moves downward and rearward according to the downward and rearward move of the seat cushion 1a. Therefore, by decreasing the knee angle θ2 to about 120 degrees accordingly, the ball of the foot Bt of the tall driver T can be made contact the pressing portion 16 of the accelerator pedal 4, keeping the ankle angle θ1 at about 90 degrees.

Since the distance (about 2060 cm) from the heel's lower end Kt of the tall driver T to the ball of the hoot Bt is about 16 mm longer than that (about 190 cm) of the average-sized driver M, in case the heel's lower end Kt is disposed at the same position, keeping the sole's inclination angle θ7 of the tall driver T at the same angle (59.5 degrees), it may be necessary that the contact position of the ball of the hoot Bt to the pressing portion 16 of the accelerator pedal 4 is lowered by about 14 mm (=sin 59.5 degrees×16 mm) than that of the average-sized driver M.

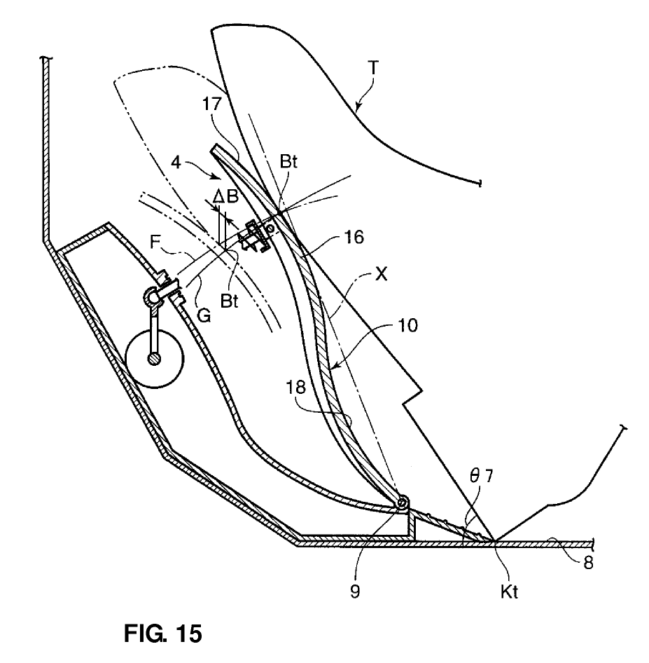

In the above-described embodiment, by changing the sole's inclination angle θ7 of the tall driver T from 59.5 degrees to about 57 degrees and moving the heel's lower end Kt onto the substantially horizontal vehicle floor 8 which is located at the rear end of the slant face portion 26 as shown in FIG. 15, the ball of the hoot Bt can be made contact the appropriate position of the pressing portion 16 of the accelerator pedal 4. Herein, there is a tendency that the ankle angle θ1 of the hoot becomes greater than 90 degrees as the sole's inclination angle θ7 changes from 59.5 degrees to 57 degrees. However, by decreasing the knee angle θ2 of the tall driver T to a specified angle smaller than 120 degrees so that the knee can bend according to the decrease of the sole's inclination angle θ7 (see FIG. 14), it can be prevented that the ankle angle θ1 becomes greater beyond the appropriate range, for example, greater than 95 degrees.

As described, the pedal device of the automotive vehicle comprises the plate-shaped pedal body 10, the lower end of which is rotatably supported at the pivot which is disposed on the vehicle floor 8 at the position where the foot of the driver seated in the driver's seat 1 is to be located, the pedal body 10 being provided so as to rotate around the pivot and swing longitudinally according to the pressing operation of the driver's foot, and the slant-face portion 26 which is provided behind the pivot (support axis 9) which supports the lower end of the pedal body 10, the slant-face portion 26 having the slant upper face which extends obliquely rearward and downward with the slant angle within the rage of 13.5 to 23.5 degrees. Accordingly, even the short driver S who has the hoot length which is shorter than that of the average-sized driver M can conduct the pressing operation of the accelerator pedal 4 easily and properly in the state in which the ball of the foot Bs is made contact the appropriate position of the pressing portion 16 of the accelerator pedal 4, maintaining the proper angles of the ankle angle θ1 and the sole's inclination angle θ7 with the driver's heel lower end Ks being stably placed on the slant-face portion 26.

Accordingly, it can be properly prevented that the accurate pedal operation becomes impossible because the heel's lower end Ks of the short driver S is positioned away from the vehicle floor face, or that the prompt pedal pressing operation becomes impossible because the ankle angle θ1 and the sole's inclination angle θ7 become greatly different from their appropriate ranges. That is, there is an advantage that the accelerator pedal 4 and the like can be pressed easily and properly with an appropriate lever ratio, by making the ball of the hoot Ms contact the appropriate position of the pressing portion 16 in the state in which the heel's lower end Ks is placed on the slant face portion 26 near the pivot as shown by the broken line in FIG. 13. Moreover, there is another advantage that changing of the pedal pressing operation can be facilitated by moving the hoot to the brake pedal 5 in the state in which the heel's lower end Ks is placed on the slant face portion 26.

Meanwhile, in case of the tall driver T, as shown in FIGS. 14 and 15, by decreasing the sole's inclination angle θ1 of the driver's hoot and the knee angle θ2, the ball of the driver's hoot Bt can be made contact the appropriate position of the pressing portion 16 easily and properly, without lowering the heel's lower end Kt. Accordingly, even if the tall driver T sets the area where the driver's heel lower end Kt is placed to the substantially-horizontal vehicle floor 8, the operational function of the accelerator pedal 4 may not deteriorate. Further, by the tall driver T setting the driver's heel lower end Kt on the vehicle floor 8 at the rear end portion of the slant face portion 26, the tall driver T can be made recognize easily that the rear end portion of the slant face portion 26 is the area where the driver's heel lower end Kt should be placed.

Moreover, since the slant angle of the upper face of the slant face portion 26 relative to the horizontal face is set within the rage of 13.5 to 23.5 degrees, the heel's lower end Ks of the short driver S can be effectively prevented from being upward away from the vehicle floor face, and the ball of the hoot Bs can be made contact the pressing portion 16 in the state in which the heel's lower end Ks of the driver is stably placed on the slant face portion 26.

That is, in case the slant angle P of the upper face of the slant face portion 26 is greater than 23.5 degrees, the heel's lower portion Ks placed on the slant face portion 26 may easily slide downward. Accordingly, by setting the slant angle P to 23.5 degrees or less, this sliding of the heel's lower portion Ks can be prevented, and the stable placement of the heel's lower portion Ks can be obtained. Further, by setting the slant angle P of the upper face of the slant face portion 26 to 13.5 degrees or less, the ball of the foot Bs can be made contact the appropriate position of the pressing portion 16 of the accelerator pedal 4 in the state in which the heel's lower end Ks of the short driver S is placed on the slant face portion 26.

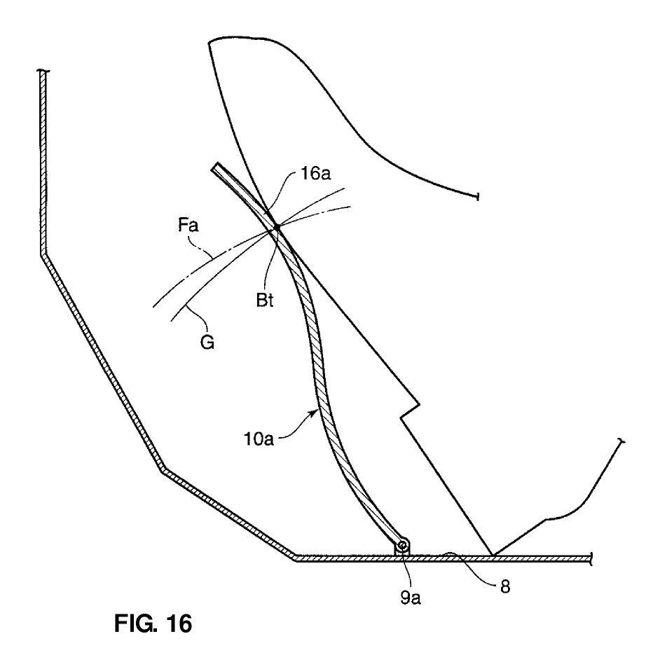

In case the slant face portion 26 is omitted and the pedal body 10a of the accelerator pedal 4 is supported around the support axis 9a which is disposed on the vehicle floor 8 as shown in FIG. 16, a swing locus Fa of a pressing portion 16a according to the pressing operation of the accelerator pedal 4 may deviate from a swing locus G of the ball of the driver's hoot Bt more greatly than the above-described embodiment. Meanwhile, in case the support axis 9 of the pivot is disposed at the front end of the slant face portion 26 as shown in FIG. 15, a deviation quantity AB between a swing locus F of the pressing portion 16 according to the pressing operation of the accelerator pedal 4 and the swing locus G of the ball of the driver's hoot Bt can be prevented from being too great.

Herein, instead of the above-described embodiment in which the slant face portion 26 is formed integrally with the base member 11 of the pedal unit to support the pedal body 10, the base member 11 and the slant face portion 26 are formed separately from each other. However, according to the above-described embodiment in which the slant face portion 26 is formed integrally with the base member 11 of the pedal unit, the structure or the attachment of the pedal device can be made simple, by reducing the number of parts properly. Further, positions of the pedal body 10 and the slant face portion 26 can be set properly so as to match each other.

Further, according to the above-described embodiment, the pedal body 10 includes the pressing portion 16 which the ball of the hoot of the driver who places the heel on the slant upper face 26, and the pressing portion 16 has the convex face which projects rearward of the vehicle. Accordingly, the pedal is pressed in the state in which the heel's lower end of the driver is located at the specified position which is located a specified distance rearward from the pivot of the pedal body 10, so that even if the contact position of the sole with the pressing portion 16 may deviate vertically according to the change of the pedal pressing quantity, it may be effectively prevented that the driver has uncomfortable feelings.

That is, in case the disposition height of the pressing portion 16 relative to the petal body 10 is set to the position which suits to the length of the sole of the short driver S, the average-sized driver M or the tall driver T who has a longer sole's length may try to make the respective foot's balls Bm, Bs contact the appropriate position (near the disposition portion of the operational rod 19) of the pressing portion 16 by moving the respective heel's lower ends Km, Kt rearward. However, in case the pressing operation of the pedal body 10 is conducted in the state in which the heel's lower end of the driver is located at the specified position which is located the specified distance rearward from the pivot of the pedal body 10 as described above, the swing locus F of the pressing portion 16 around the support axis 9 and the swing locus G of the ball of the driver's hoot Bm around the heel's lower end Kt draw different arcs as shown in FIG. 15. Accordingly, it may be inevitable that the contact position of the driver's sole with the pedal pressing face changes toward the toe side according to the increase of the pressing quantity of the pedal body 10.

In this case, if the pressing portion of the pedal body 10 is formed in a straight-line shape, or the side-face shape of the pedal pressing face is formed in a concave shape so that the back face of the driver's shoe contacts the pedal pressing face with a face contact, the contact position of the driver's sole with the pedal pressing face changes toward the toe side with an intermittent slipping according to the increase of the pressing quantity of the pedal body 10. This intermittent slipping over the pressing face may provide the driver with the uncomfortable feelings.

Since the pressing portion 16 which is located above the concave face portion 18 is formed so as to have the convex face which projects rearward of the vehicle according to the above-described embodiment, the back face of the driver's shoe is made contact a point of the convex face of the pressing portion 16 with a line contact. Accordingly, if the tall driver T presses the pedal in the state in which the heel's lower end Kt is located at the specified position which is located the specified distance rearward from the pivot of the pedal body 10, the contact position of the back face of the driver's shoe with the pressing portion 16 can change smoothly and continuously according to the pressing of the pedal. Thus, the above-described uncomfortable feelings by the driver can be effectively prevented.

In particular, in case the upper face of the pedal is formed in the convex shape with the bend portion 17 and the pressing portion 16 like the above-described embodiment, the bend portion 17 also performs the function of the pressing portion so that the driver's foot can use the bend portion 17 for pressing the accelerator pedal 4. Thus, the pedal operation can be improved effectively with the simple structure.

Further, since the concave face portion 18 is formed between the pressing portion 16 and the pivot (support axis 9) so as to be recessed forward from the imaginary line X which connects these according to the above-described embodiment, the deterioration of the pedal operation or the driver's uncomfortable feelings, which may be caused by the driver's heel contacting the position near the base end portion of the pedal body 10, can be effectively prevented.

That is, in the so-called organ type of pedal in which the pedal body 10 is provided so as to swing around the support axis 9 of the pivot which is disposed on the vehicle floor 8, by moving the heel's lower end Ks of the short driver S forward greatly near the pivot, for example, a swing locus N of the pressing portion 16 around the support axis 9 and a swing locus of the ball of the driver's hoot Bs around the heel's lower end Ks can be located so as to be substantially in parallel to each other. Thereby, it can be effectively restrained that the contact position of the sole with the pressing portion 16 deviates vertically according to the change of the pressing quantity of the pedal body 10. Thus, it can be prevented that the driver has uncomfortable feelings or the pressing operation of the pedal deteriorates.

Further, as shown by the broken line in FIG. 13, when the heel's lower end Ks of the driver's hoot is located near the pivot of the accelerator pedal 4, an interference concern area Kr where the shoe's heel portion K with a specified height might improperly contact (interfere with) a specified portion of the pedal body 10 near its base end portion is formed near the base end portion of the pedal body 10. Herein, if the interference occurs in this area Kr, the driver may have the uncomfortable feelings, and the pedal operation function which is performed by pressing the pressing portion 16 with the ball of the hoot Bs may deteriorate. However, according to the structure in which the concave face portion 18 is formed between the pressing portion 16 and the support axis 9 of the pivot so as to be recessed forward from the imaginary line X which connects these, even when the short driver S places the heel's lower end Ks near the pivot of the accelerator pedal 4, it can be effectively prevented that the shoe's heel portion K contacts (interferes with) the pedal body 10 near its base end portion.

Accordingly, by making the swing locus N of the pressing portion 16 around the support axis 9 substantially mach the swing locus of the ball of the driver's hoot Bs around the heel's lower end Ks, the above-described driver having the unconformable feelings or interference of the pedal operation can be prevented effectively without deteriorating the above-described operational function of the organ type of pedal.

Herein, the concave face portion 18 which is formed at the area from the pivot of the to the pressing portion 16 of the pedal body 10 may be formed with another structure in which a concave face portion which has a V-shaped cross section or the like is formed at a lower portion of the pedal body 10 in place of the structure of the above-described embodiment.

Further, since the bend portion 17 is provided above the pressing portion 16 so as to curve forward from the imaginary line X which interconnects the pressing portion 16 and the support axis 9 of the pivot in such a manner that its upper-side portion curves more greatly so as to be away from the imaginary line X according to the above-described embodiment, the driver having the uncomfortable feelings, which may be caused by the contact of the upper end of the pedal body 10 with the toe portion of the driver's shoe during the pressing operation of the accelerator pedal 4, can be effectively prevented.

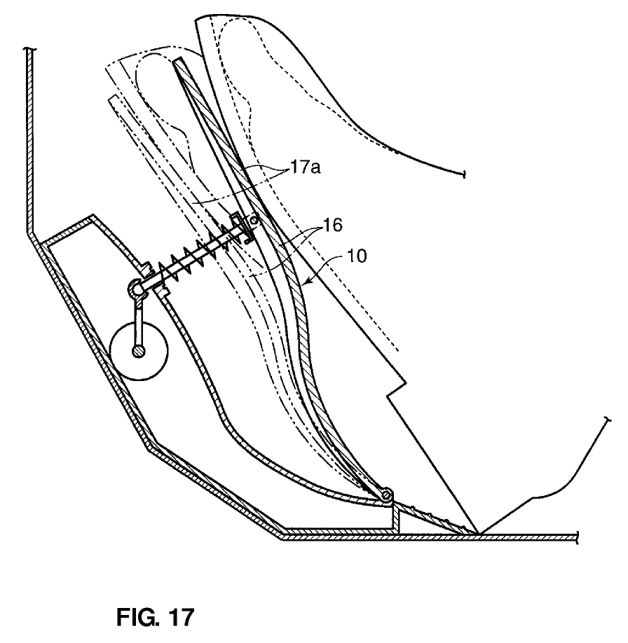

In case the pressing operation of the pedal body 10 is conducted in the state in which the heel's lower end of the driver is located at the specified position which is located the specified distance rearward from the pivot of the pedal body 10 as described above, the toe portion of the driver's shoe tends to lower gradually as the depressing quantity increases. Therefore, if an upper portion 17a of the pedal body 10 is formed in a straight-line shape as shown in FIG. 17, or in a curve shape in such a manner it projects forward, the toe portion of the driver's hoot lowers according to the pressing operation of the pedal body 10, and the back face of the driver's shoe may be deformed in a flat shape by a reaction force which acts on the back face of the shoe accordingly, so that the toe portion of the driver's shoe tends to approach the upper portion 17a of the pedal body 10 and contact that portion easily. This situation may cause the improper pedal operation by the pressing of the pressing portion 16, so that the driver may have the uncomfortable feelings.

By contrast, in case, like the above-described embodiment, the pressing portion 16 and the bend portion 17 are formed at the upper end portion of the pedal body 10 so that the upper end portion of the pedal body 10 is positioned forward from the imaginary line X which connects the pressing portion 16 and the support axis 9 of the pivot, by pressing the pedal body 10 in the state in which the heel's lower end Kt of the driver is located at the specified position which is located the specified distance rearward from the pivot of the pedal body 10 as shown in FIG. 15, the driver's having the uncomfortable feelings which may be caused by the contact of the upper portion (bend portion 17) of the pedal body 10 with the toe portion of the back face of the driver's shoe can be prevented even if the lowering quantity of the toe portion of the driver's shoe increases according to the pedal pressing operation.

In particular, in case the upper face of the pedal is formed in the convex shape with the bend portion 17 and the pressing portion 16 like the above-described embodiment, the bend portion 17 also performs the function of the pressing portion so that the driver's foot can use the bend portion 17 for pressing the accelerator pedal 4. Thus, the pedal operation can be improved effectively with the simple structure.

Further, since the S-shaped continuous curve face is formed by the convex-shaped portion which is comprised of the bend portion 17 and the pressing portion 16 and the concave-shaped face portion 18 which is formed between the pressing portion 16 and the pivot according to the above-described embodiment, the heel portion K of the driver's shoe can be prevented from contacting the base end portion of the pedal body 10 during the pressing operation of the accelerator pedal 4 with the simple structure. Further, the driver's having the uncomfortable feelings which may be caused by the contact of the upper portion of the pedal body 10 with the toe portion of the back face of the driver's shoe can be effectively prevented, and the superior design of the operational pedal can be provided.

Moreover, according the above-described embodiment, in the vehicle in which the brake pedal 5 is disposed on the left side of the accelerator pedal 4 as shown in FIG. 5, the pressing portion 16 having the convex face is provided at the pedal body 10 of the accelerator pedal 4, and the layout of the brake pedal 5 and the accelerator pedal 10 is configured in such a manner that the imaginary line Y which extends obliquely downward and to the right from the pressing portion 40 of the brake pedal 5 with the inclination angle of about 45 degrees passes through the lower half portion of the convex face portion (the pressing portion 16) of the accelerator pedal 4. Thereby, the so-called heel-and-toe driving can be executed easily and properly.

That is, in the vehicle with the manual transmission, the driver operates the pedals in such a manner that the brake pedal 5 is pressed with the toe (the ball of the hoot B) of the driver's right hoot and at the same time the accelerator pedal 4 is pressed with the driver's heel (the heel portion K) during the cornering with the speed reduction, aiming at executing the shift down to prepare for the driving after the cornering. In this case, by positioning the heel portion K on the above-described about 45-degree line when the ball of the driver's right hoot B contacts the pressing portion 40 of the brake pedal 5, the pedal pressing can be executed properly with the driver's easy contacting of the heel portion K of the driver's right hoot with the lower half portion of the pressing portion 16 having the convex face.

Accordingly, there may not occur any problems in that the driver is forced to take an uneasy position in which the driver has to make the heel portion K contact the upper portion of the accelerator pedal 4 by twisting the right hoot greatly, or that the large pressing force is required because of the small lever ratio by the contact of the heel portion K with the lower portion of the accelerator pedal 4. Thus, both the brake pedal 5 and the accelerator pedal 4 can be operated properly in the easy (comfortable) position for executing the heel-and-toe driving.

In particular, the situation in which the precise adjusting of the pressing operation of the accelerator pedal 4 may become difficult due to the contacting of the heel portion K with the lower portion of the accelerator pedal 4 can be effectively prevented by adopting the structure in which the concave face portion 18 is formed between the pressing portion 16 and the pivot of the pedal body 10 so as to be recessed forward from the imaginary line X which connects these as described above. Herein, in place of the above-described hanging type of brake pedal 5, an organ type of brake pedal, in which its lower end is rotatably supported at a pivot which is disposed on the vehicle floor 8, and its plate-shaped pedal body is configured to swing around the pivot according to the pressing operation by the driver, may be used.

Further, according to the above-described embodiment, the seat adjusting mechanism which comprises the longitudinal-position adjusting mechanism 2 and the inclination-angle adjusting mechanism 3 which moves the driver's seat 1 longitudinally and the rearward-inclination angle of the seat cushion 1a is decreased according to the forward move of the driver's seat 1. Thereby, by setting the drive characteristics of the longitudinal-position adjusting mechanism 2 and the inclination-angle adjusting mechanism 3 properly for the height of the driver, the driver's eye point can be made match the appropriate line L, keeping the sitting position of the driver properly, and the longitudinal position of the driver's seat 1 and the inclination angle of the seat cushion 1a can be automatically adjusted so as to provide the superior operational functions of the steering wheel and the pedals.

Herein, even in case the sitting position of the driver seated in the driver's seat 1 changes depending on the adjusting move of the longitudinal position of the driver's seat 1 and the inclination angle of the seat cushion 1a, the slant face portion 26 enables the ball of the hoot Bs of the short driver S to contact the pressing portion 16 of the accelerator pedal 4, keeping the ankle angle θ1 and the sole's inclination angle θ7 at the respective appropriate angles for the operation of the accelerator pedal 4, in the state in which the hell's lower end Ks of the short driver S having the relatively short hoot's length is placed on the slant face portion 26. Consequently, the pedal operational function can be ensured. While the above-described embodiment describes an example in which the driver's seat 1 is automatically moved by the switching operation of the driver and the inclination angle of the seat cushion 1a is adjusted so as to decrease according to the forward move of the driver's seat 1 by using the longitudinal-position adjusting mechanism 2 and the inclination-angle adjusting mechanism 3, the longitudinal position of the driver's seat 1 and the inclination angle of the seat cushion 1a may be adjusted by a manual operation of the driver.

The present invention should not be limited to the above-described embodiments, and any other modifications and improvements may be applied within the scope of a spirit of the present invention.

What is claimed is:

1. A pedal device of an automotive vehicle, comprising:
a plate-shaped pedal body, a lower end of which is rotatably supported at a pivot which is disposed on a vehicle floor at a position where a foot of a driver seated in a driver's seat is to be located, the pedal body being provided so as to rotate around the pivot and swing longitudinally according to a pressing operation of the driver's foot; and
a slant-face member provided behind said pivot which supports the lower end of said pedal body, the slant-face member having a slant upper face which extends obliquely rearward and downward with a slant angle within a rage of 13.5 to 23.5 degrees.

2. The pedal device of an automotive vehicle of claim 1, wherein said pedal body includes a pressing portion which a ball of a foot of the driver who places a heel thereof on the slant upper face of said slant-face member contacts, and the pressing portion of the pedal body has a convex face which projects rearward of the vehicle.

3. The pedal device of an automotive vehicle of claim 2, wherein said pedal body is a pedal body of an accelerator pedal of the vehicle, a brake pedal is disposed on a left side of the accelerator pedal, and a layout of the accelerator pedal and the brake pedal is configured in such a manner that an imaginary line which extends obliquely downward and toward a right side from a pressing portion of the brake pedal with an inclination angle of about 45 degrees passes through a lower half portion of said convex face of the pressing portion of the accelerator pedal.

4. The pedal device of an automotive vehicle of claim 2, wherein a concave face portion is formed at the pedal body which is located between said pressing portion and said pivot, the concave face portion being configured to be recessed forward from an imaginary line which connects the pressing portion and the pivot of the pedal body, and an S-shaped continuous curve face of the pedal body is formed by said concave face portion and said convex face portion.

5. The pedal device of an automotive vehicle of claim 4, further comprising a base member of a pedal unit which supports said pedal body, wherein said slant-face member and the base member are formed integrally.

6. The pedal device of an automotive vehicle of claim 3, wherein a concave face portion is formed at the pedal body which is located between said pressing portion and said pivot, the concave face portion being configured to be recessed forward from an imaginary line which connects the pressing portion and the pivot of the pedal body, and an S-shaped continuous curve face of the pedal body is formed by said concave face portion and said convex face portion.

7. The pedal device of an automotive vehicle of claim 6, further comprising a base member of a pedal unit which supports said pedal body, wherein said slant-face member and the base member are formed integrally.
